(19) United States
(12) Patent Application Publication
(10) Pub. No.: US 2015/0359305 A1
(43) Pub. Date: Dec. 17, 2015

(54) DECORATIVE COVERING DEVICE

(71) Applicants: Charles Shapiro, Las Vegas, NV (US); Mary Lou Shapiro, Las Vegas, NV (US)

(72) Inventors: Charles Shapiro, Las Vegas, NV (US); Mary Lou Shapiro, Las Vegas, NV (US)

(21) Appl. No.: 14/306,003

(22) Filed: Jun. 16, 2014

(51) Int. Cl. A45B 3/00; B32B 3/28; B32B 7/12; B32B 5/02; B32B 5/16

(52) U.S. Cl. CPC A45B 3/00; B32B 5/024; B32B 5/16; B32B 7/12; B32B 3/28; B32B 2262/103; B32B 2451/00; B32B 2475/00

(57) ABSTRACT

A covering device wraps around a mobility aid, such as a walking cane, to display a decorative design. The device includes at least one panel that can be triggered to form a tensioned grip on a mobility aid and display a decoration, message, or image on a portion of the mobility aid. A spring layer having a slight curve and woven metal coils creates a tension therebetween. The tension is released upon contact with the mobility aid to enable the panel to wrap around the mobility aid and form a snug grip. The panel also utilizes a mounting layer having a frictional polyurethane composition creating friction with the mobility aid and creating a non-slip surface. While joined with the mobility aid, the covering device displays a decoration, message, label, or symbol in the form of a decorative portion, like rhinestones, enabling personal expression.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a mobility aid covering device. More particularly, the invention relates to a covering device that can be triggered to create a tensioned grip on a mobility aid for displaying a decoration, message, or image on a portion of the mobility aid.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a mobility aid can include a walking cane. The walking cane can be used as a crutch.

Typically, walking canes can help redistribute weight from a lower leg that is weak or painful, improve stability by increasing the base of support, and provide tactile information about the ground to improve balance. Often, the handle of a cane is extremely important to the user.

In many instances, the collar of a cane may be only a decorative addition made for stylistic reasons, or may form the structural interface between a shaft and the handle. The shaft of the cane transmits the load from the handle to the tip. The tip of a cane provides traction and added support when the cane is used at an angle.

Typically, a rhinestone is a diamond simulant made from rock crystal, glass, or acrylic. The rhinestones can be individually placed on a surface to form a desired design. The rhinestones can also be very colorful to further enhance a decorative effect.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, and 1C illustrate detailed perspective views of an exemplary covering device joined with an exemplary mobility aid, where FIG. 1A illustrates the mobility aid in a planar configuration in proximity to the mobility aid, FIG. 1B illustrates the covering device forming a partial encapsulation around the mobility aid, and FIG. 1C illustrates the covering device at least partially wrapped around the mobility aid, in accordance with an embodiment of the present invention;

FIGS. 2A and 2B illustrate detailed perspective views of an exemplary panel, where FIG. 2A illustrates a top angle view of the panel with exemplary multiple layers, and FIG. 2B illustrates a side view of the panel with the multiple layers, in accordance with an embodiment of the present invention;

FIGS. 3A and 3B illustrate detailed perspective views of an exemplary panel, where FIG. 3A illustrates a top view of an exemplary decorative portion, and FIG. 3B illustrates a bottom view of an exemplary mounting layer, in accordance with an embodiment of the present invention;

FIGS. 4A and 4B illustrate detailed perspective views of an exemplary spring layer, where FIG. 4A illustrates a top view and a close up view of the spring layer in a flat configuration and the plurality of strips of stainless steel, and FIG. 4B illustrates a side view of the spring layer in a coiled configuration, in accordance with an embodiment of the present invention; and

FIGS. 5A and 5B illustrate detailed perspective views of exemplary embodiments of a covering device, where FIG. 5A illustrates a top angle view of an exemplary decorative portion configured into a decorative design, and FIG. 5B illustrates a side view of three separate panels joined with the mobility aid, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of covering devices that may be provided by preferred embodiments of the present invention. In one embodiment of the present invention, the covering device helps enhance the appearance of a walking cane. The device may include a decorative panel that can be triggered to create a tensioned grip on a mobility aid for displaying a decoration, message, or image on a portion of the mobility aid. The covering device may include at least one panel. The panel at least partially wraps around the mobility aid to form a snug grip thereto. The panel also utilizes a friction to further secure to the mobility aid. While joined with the mobility aid, the covering device displays a decoration, message, label, or symbol.

In some embodiments, the mobility aid may include, without limitation, a cane, a walking stick, and a wheel chair. The covering device may at least partially encapsulate a shaft on the cane, a leg on the wheel chair, or generally any linear member on the mobility aid. In one embodiment, the device may include a decorative panel that encircles a shaft on a walking cane. The device may include a generally planar member having multiple layers. The device may be configured to wrap around the shaft along any portion of the shaft, between the handle and the tip.

In some embodiments, the device may include at least one panel. The panel may take a generally flat shape that is sufficiently resilient to at least partially wrap around a linear member on the mobility aid. The device may include a decorative portion that forms the most visible part of the device. In one embodiment, the decorative portion may include numerous rhinestones that combine to create a design. The decorative portion may rest on an exterior layer, whereby the decorative portion is strategically positioned over the exterior layer to create the desired decorative effect. The exterior layer may include a cotton or polyester fabric. The at least one decorative member may utilize an adhesive, such as an epoxy resin, to securely fasten to the exterior layer from either a planar or curved configuration.

In some embodiments, the device may include a spring layer positioned beneath the exterior layer. The spring layer may be fabricated from a plurality of metal coils that help form the structural frame for the device. In some embodiments, the spring layer may include multiple strands of metal configured into a woven format. The woven format may help ensure that the integrity of a bi-stable quality remains intact even after wrapping and unwrapping multiple times from around the mobility aid. In some embodiments, the spring layer may automatically grip the mobility aid on contact, forming the encapsulating shape around the mobility member.

In one embodiment, the spring layer may not be completely flat, but rather have a slightly curved shape. Additionally, the metal coils that make up the spring layer may be woven in an opposite direction to the curve. This creates a tension on the spring layer. Upon contact with the mobility aid, the tension may be relieved, and the spring layer is released to wrap around the mobility aid in the direction of the curve. In essence, the slight curve combined with the fabrication of the spring layer enables the spring layer to be triggered into wrapping around the mobility aid upon contact.

In some embodiments, the spring layer rests on an interior layer. Similar to the exterior layer, the interior layer may include a cotton or polyester fabric. In this manner, the exterior and interior layers form a sandwich over the spring layer. Those skilled in the art will recognize that the tensioned grip formed by the spring layer may not be sufficient to fasten the device onto the mobility aid alone. Therefore, the panel may further include a mounting layer that helps securely join the device with the outer surface of the mobility aid. The mounting layer may include a frictional polyurethane panel that has an affinity to grip surfaces. In this manner, the frictional grip of the mounting layer and the wrapping functionality of the spring layer form an easily triggered, slip free, and secure attachment between the device and the mobility aid. Further, the decorative portion may form the decorative, image, or message delivering functionality for the device.

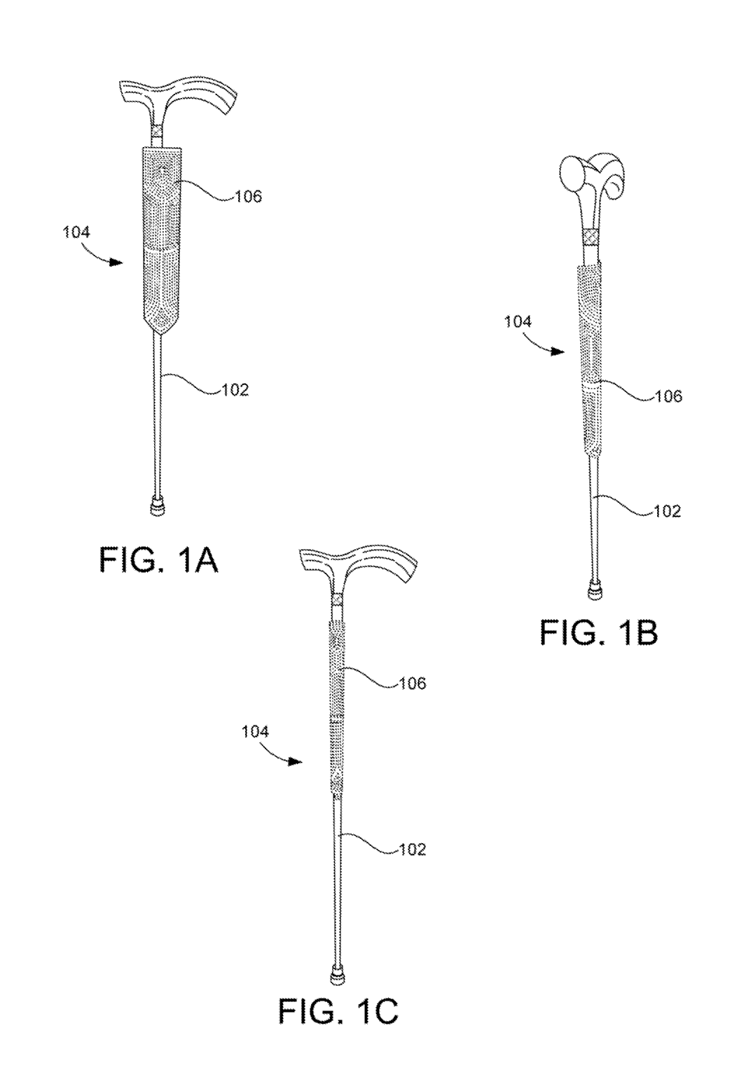

FIGS. 1A, 1B, and 1C illustrate detailed perspective views of an exemplary covering device joined with an exemplary mobility aid, where FIG. 1A illustrates the mobility aid in a planar configuration in proximity to the mobility aid, FIG. 1B illustrates the covering device forming a partial encapsulation around the mobility aid, and FIG. 1C illustrates the covering device at least partially wrapped around the mobility aid, in accordance with an embodiment of the present invention. In the present invention, a covering device 100 may include a decorative panel that can be triggered to create a tensioned grip on a mobility aid 102 for displaying a decoration, message, or image on a portion of the mobility aid. In one embodiment, the device helps enhance the appearance of a walking cane.

The covering device may include at least one panel 104. In some embodiments, the panel at least partially wraps around the mobility aid to form a snug grip thereto. The panel also utilizes a friction to further secure to the mobility aid. While joined with the mobility aid, the covering device displays a decoration, message, label, or symbol in the form of a decorative portion 106. The decorative portion may include, without limitation, a plurality of rhinestones, sequins, non-precious stones, semi-precious stones, precious stones, colored and non-colored glass, fabrics. In one embodiment, the at least one panel comprises a base measuring approximately 12″ in length by 2¾″, with the width determined for accommodation of encasement of a walking cane having standard diameter of ⅞″. The panel may be ⅛″ thick. However in other embodiments, other lengths, widths, and thicknesses may be utilized. In another embodiment, the at least one panel may include a single unit of 12″ height, or may include three units of four-inch 4″ height. In aforementioned non-limiting example, the individual units can be displayed equidistant from each other, or variably spaced when placed on a walking cane.

In some embodiments, the mobility aid may include, without limitation, a cane, a walking stick, a wheel chair, crutches, a mobility scooter handle bars or seat frame, a walker, a rollator, a household trolley, as well as on a bicycle and a broom handle. The covering device may at least partially encapsulate a shaft on the cane, a leg on the wheel chair, or generally any linear member on the mobility aid. In one embodiment, the device may include a decorative panel that encircles a shaft on a walking cane. The device may include a generally planar member having multiple layers. The device may be configured to wrap around the shaft along any portion of the shaft, between the handle and the tip.

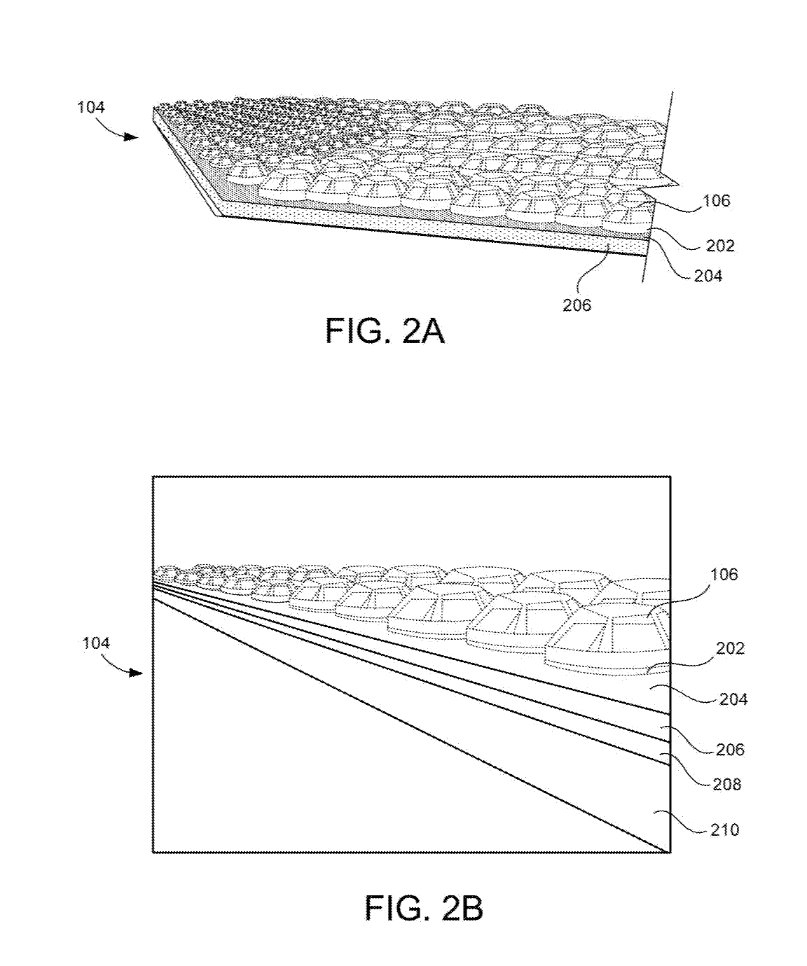

FIGS. 2A and 2B illustrate detailed perspective views of an exemplary panel, where FIG. 2A illustrates a top angle view of the panel with exemplary multiple layers, and FIG. 2B illustrates a side view of the panel with the multiple layers, in accordance with an embodiment of the present invention. In the present invention, the device may include at least one panel. The panel may take a generally flat shape that is sufficiently resilient to at least partially wrap around a linear member on the mobility aid. The device may include a decorative portion that forms the most visible part of the device. In one embodiment, the decorative portion may include numerous rhinestones that combine to create a design. However in other embodiments, the decorative portion may include, without limitation, beads, colored stones, sequins, semiprecious and non-precious stones, and artwork pieces made of metal, glass, plastic, paint, ribbons, text, pictures, logos, and any artistic or decorative member.

In some embodiments, the decorative portion may rest on an exterior layer 204, whereby the decorative portion is strategically positioned over the exterior layer to create the desired decorative effect. The exterior layer may include a cotton or polyester fabric. The at least one decorative member may utilize an adhesive 202, such as an epoxy resin, to securely fasten to the exterior layer from either a planar or curved configuration. In some embodiments, the exterior layer may include a resilient composition configured to help retain the decorative portion on the exterior layer when the at least one panel at least partially wraps around the mobility aid. The flex allowed by the resiliency is efficacious for keeping the rhinestones stable and held stable on the exterior layer.

In some embodiments, the device may include a spring layer 206 positioned beneath the exterior layer. The spring layer may be fabricated from a plurality of metal coils that help form the structural frame for the device. In one embodiment, the spring layer may not be completely flat, but rather have a slightly curved shape. The curve may take a convex shape. Additionally, the metal coils that make up the spring layer may be woven in an opposite direction to the curve. This creates a tension on the spring layer. Upon contact with the mobility aid, the tension may be relieved, and the spring layer is released to wrap around the mobility aid in the direction of the curve. In essence, the slight curve combined with the fabrication of the spring layer enables the spring layer to be triggered into wrapping around the mobility aid upon contact. For example, without limitation, tapping the cane against the panel triggers the panel to wrap around the mobility aid. The spring layer can be produced from various plastics. Instead of the spring layer as described a tension frame can be enclosed or sandwiched between the fabric layers.

In some embodiments, the spring layer rests on an interior layer 208. Similar to the exterior layer, the interior layer may include a cotton or polyester fabric. In this manner, the exterior and interior layers form a sandwich over the spring layer. Those skilled in the art will recognize that the tensioned grip formed by the spring layer may not be sufficient to fasten the device onto the mobility aid alone. Therefore, the panel may further include a mounting layer 210 that helps securely join the device with the outer surface of the mobility aid. The mounting layer may include a frictional polyurethane panel that has an affinity to grip surfaces. Through the use of the frictional grip from the mounting layer and the tensioned wrapping functionality of the spring layer the device forms an easily triggered, slip free, and secure attachment between the device and the mobility aid. Further, the decorative portion may form the decorative, image, or message delivering functionality for the device. Residue free adhesives, residue free adhesive wax paper peel offs, ridged or grooved surface, hook-and-loop material, magnets, or anything other than a smooth, slick surface may also be used.

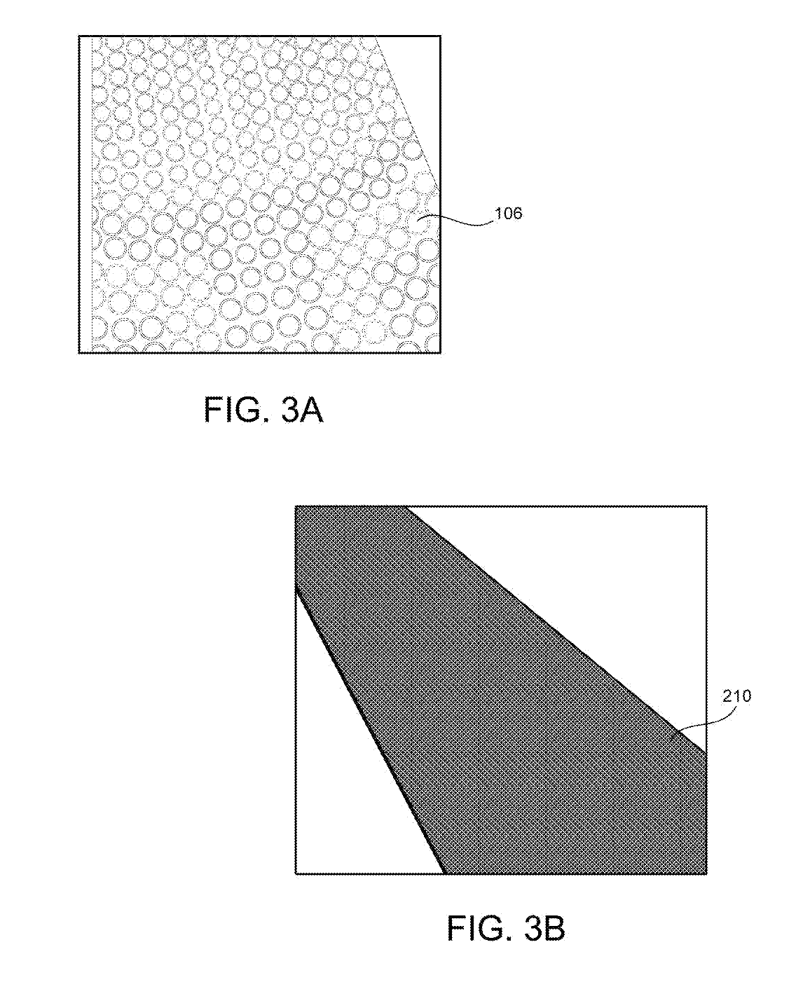

FIGS. 3A and 3B illustrate detailed perspective views of an exemplary panel, where FIG. 3A illustrates a top view of an exemplary decorative portion, and FIG. 3B illustrates a bottom view of an exemplary mounting layer, in accordance with an embodiment of the present invention. In the present invention, the decorative portion forms the most visual part of the device. The decorative portion may include a plurality of rhinestones or other decorative members configured on the exterior layer to form a design, a message, a decoration, or an image. Those skilled in the art, in light of the present teachings will recognize that the decorative portion may provide multiple formats of decoration for use on walking canes. The decorative portion may personalize the appearance of their walking canes. The decorative portion may remove the impersonal appearance that most walking canes otherwise have by potentially making a personal expression. In some embodiments, the mounting layer may utilize frictional forces to form a slip free engagement with the mobility aid. In some embodiments, the mounting layer may also utilize a sticky substance, a hook and loop fastener, or a magnet to further enhance the attachment to the mobility aid.

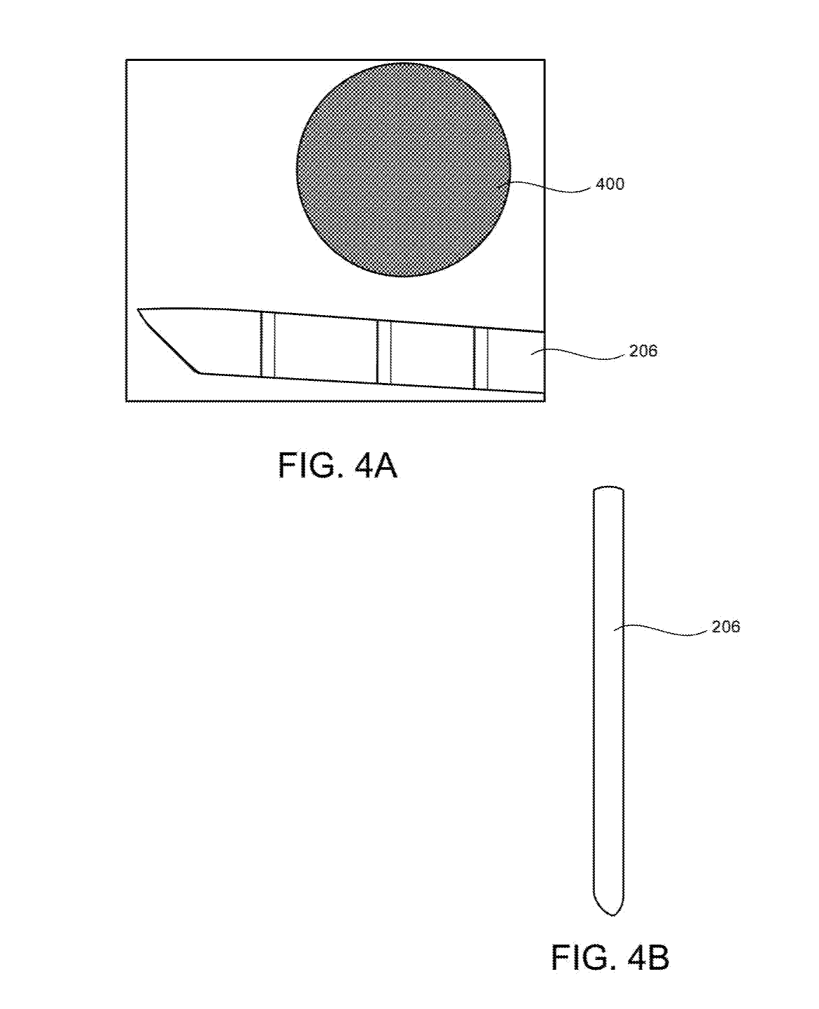

FIGS. 4A and 4B illustrate detailed perspective views of an exemplary spring layer, where FIG. 4A illustrates a top view and a close up view of the spring layer in a flat configuration and the plurality of strips of stainless steel, and FIG. 4B illustrates a side view of the spring layer in a coiled configuration, in accordance with an embodiment of the present invention. In the present invention, the spring layer may be fabricated from a plurality of metal coils that help form the structural frame for the device. In some embodiments, the spring layer may include multiple strands of metal configured into a woven format. The multiple strands may include a plurality of strips of stainless steel 400. The woven format may help ensure that the integrity of a bi-stable quality remains intact even after wrapping and unwrapping multiple times from around the mobility aid. In some embodiments, the spring layer may automatically grip the mobility aid on contact, forming the encapsulating shape around the mobility member.

In one embodiment, the spring layer may not be completely flat, but rather have a slightly curved shape. The curve may take a convex shape. Additionally, the metal coils that make up the spring layer may be woven in an opposite direction to the curve. This creates a tension on the spring layer. Upon contact with the mobility aid, the tension may be relieved, and the spring layer is released to wrap around the mobility aid in the direction of the curve. In essence, the slight curve combined with the fabrication of the spring layer enables the spring layer to be triggered into wrapping around the mobility aid upon contact. For example, without limitation, tapping the can against the panel triggers the panel to wrap around the mobility aid. In one embodiment, the spring layer may be approximately 1/32″ thick. In another embodiment, the spring layer may include rigid materials other than metal or stainless steel, such as rigid polymers.

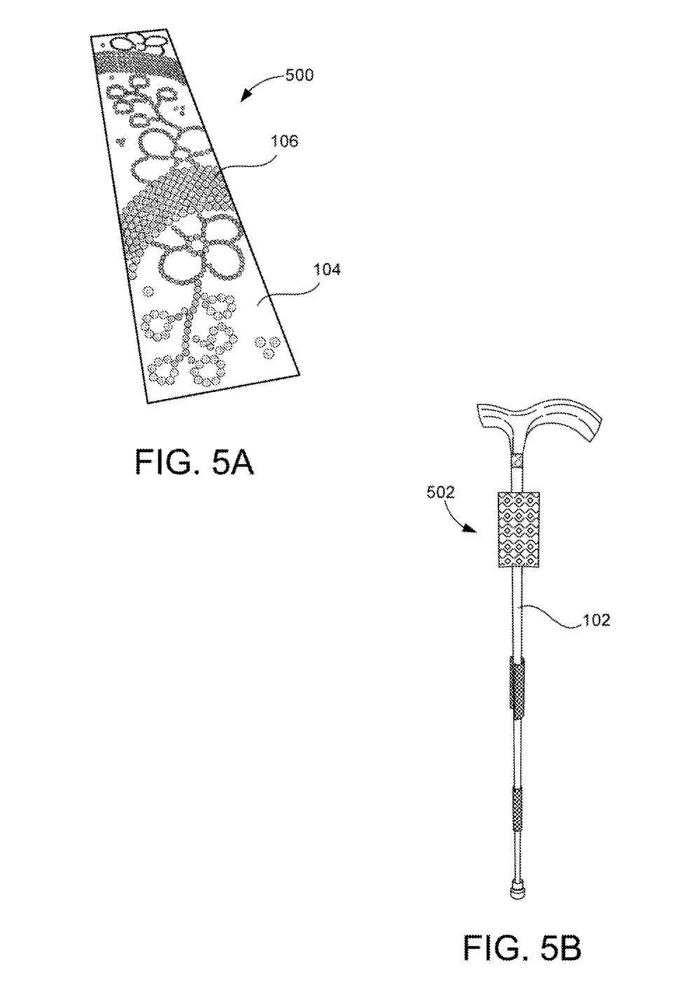

FIGS. 5A and 5B illustrate detailed perspective views of exemplary embodiments of a covering device, where FIG. 5A illustrates a top angle view of an exemplary decorative portion configured into a decorative design, and FIG. 5B illustrates a side view of three separate panels joined with the mobility aid, in accordance with an embodiment of the present invention. In the present invention, the device may have the decorative portion configured to from a decorative design 500. The decorative design may include rhinestones that are glued to form an image of flowers, rainbows, text, and various geometric shapes.

In some embodiments, the at least one panel may include three separate panels 502 positioned equidistant from each other along a shaft of the mobility aid. The three separate panels may wrap around the mobility aid in the same manner as a single panel. The three panels may also be coordinated to share the same decorative portion, or may utilize different colors, textures, and lengths. However in other embodiments, the at least one panel may include more than three panels.

In one alternative embodiment, the decorative portion may be configured to form or include text that identifies the owner or purpose of the mobility aid. In yet another alternative embodiment, the at least one panel may include illumination and audio. In yet another alternative embodiment, the panel may wrap around the mobility aid with hinges and a lock, rather than tension from the spring layer.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a decorative covering device that automatically wraps around a mobility aid upon contact according to the present invention will be apparent to those skilled in the art. Various aspects of the invention have been described above by way of illustration, and the specific embodiments disclosed are not intended to limit the invention to the particular forms disclosed. The particular implementation of the decorative covering device that automatically wraps around a mobility aid upon contact may vary depending upon the particular context or application. By way of example, and not limitation, the decorative covering device that automatically wraps around a mobility aid upon contact described in the foregoing were principally directed to a decorative panel that uses spring tension to wrap around a walking cane; however, similar techniques may instead be applied to any linear member beyond mobility aids, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device comprising:
at least one panel configured to display a decoration, a message, or an image while joined with the mobility aid,
the at least one panel comprising a decorative portion configured to at least partially form the decoration, the message, or the image,
the at least one panel further comprising a spring layer configured to create a tension on the at least one panel, the tension operable to be released upon contact with the mobility aid,
wherein the released tension enables the at least one panel to at least partially wrap around the mobility aid,
the at least one panel further comprising a mounting layer configured to frictionally engage the mobility aid,
wherein the frictional engagement enables the at least one panel to at least partially wrap around the mobility aid.

2. The device of claim 1, in which the mobility aid comprises a walking cane.

3. The device of claim 2, wherein the at least one panel is configured to join with a shaft on the walking cane.

4. The device of claim 3, in which the at least one panel comprises a dimension of 12 inches×2¾ inches.

5. The device of claim 4, in which the decorative portion is configured to rest on an exterior layer.

6. The device of claim 5, in which the decorative portion comprises an adhesive for fastening the decorative portion to the exterior layer.

7. The device of claim 6, in which the exterior layer comprises a resilient composition, the resilient composition configured to help maintain the decorative portion on the exterior layer when the at least one panel at least partially wraps around the mobility aid.

8. The device of claim 7, in which the exterior layer comprises cotton and/or nylon.

9. The device of claim 8, in which the decorative portion comprises a plurality of rhinestones.

10. The device of claim 9, in which the spring layer comprises a convex curve.

11. The device of claim 10, in which the spring layer comprises a directional woven configuration, the directional woven configuration comprising a woven spring metal band, the woven spring metal band comprising a plurality of strips of stainless steel.

12. The device of claim 11, wherein the tension occurs between the directional woven configuration and the convex curve.

13. The device of claim 12, in which the at least one panel comprises an interior layer.

14. The device of claim 13, wherein the spring layer is configured to rest on the interior layer.

15. The device of claim 14, in which interior layer comprises cotton and/or nylon.

16. The device of claim 15, in which the adhesive comprises an epoxy resin.

17. The device of claim 16, in which the mounting layer comprises a frictional polyurethane.

18. The device of claim 17, in which the at least one panel comprises a two pieced hinged snap bracket or a single-pieced C-bracket.

19. A device comprising:
means for joining at least one panel with a mobility aid;
means for releasing a tension on a spring layer;
means for at least partially wrapping the at least panel around the mobility aid;
means for engaging a mounting layer with the mobility aid;
means for generating friction between the mounting layer and the mobility aid; and
means for displaying a decorative portion on the at least one panel.

20. A device consisting of:
at least one panel configured to display a decoration, a message, or an image while joined with the mobility aid, the mobility aid comprising a walking cane,
the at least one panel configured to join with a shaft on the walking cane,
the at least one panel comprising a decorative portion configured to at least partially form the decoration, the message, or the image, the decorative portion comprising a plurality of rhinestones, the decorative portion further configured to rest on an exterior layer, the exterior layer comprising a resilient composition, the resilient composition configured to help maintain the decorative portion on the exterior layer when the at least one panel at least partially wraps around the mobility aid,
the at least one panel further comprising a spring layer configured to create a tension on the at least one panel, the tension operable to be released upon contact with the mobility aid, the spring layer comprising a convex curve,
wherein the released tension enables the at least one panel to at least partially wrap around the mobility aid, the spring layer further comprising a directional woven configuration, the directional woven configuration comprising a woven spring metal band, the woven spring metal band comprising a plurality of strips of stainless steel,
the at least one panel further comprising a mounting layer configured to frictionally engage the mobility aid, the mounting layer comprising a frictional polyurethane,
wherein the frictional engagement enables the at least one panel to at least partially wrap around the mobility aid.
